(19) United States
(12) Patent Application Publication
(10) Pub. No.: US 2026/0318122 A1
(43) Pub. Date: Oct. 15, 2026

(54) LOCK CONTROL SYSTEM FOR VEHICLE DOOR

(71) Applicant: TOYOTA JIDOSHA KABUSHIKI KAISHA, Aichi-ken (JP)

(72) Inventor: Tetsuya NAGASAKI, Okazaki-shi (JP)

(21) Appl. No.: 19/387,625

(22) Filed: Nov. 13, 2025

(30) Foreign Application Priority Data
Apr. 14, 2025 (JP) 2025-066325

(51) Int. Cl. E05B 77/54; E05B 81/06; E05B 81/14; E05B 81/56

(52) U.S. Cl. CPC E05B 77/54; E05B 81/06; E05B 81/56; E05B 81/14

(57) ABSTRACT

While the vehicle is traveling, the lock controller executes lock control on an inside handle and an outside handle provided on the respective vehicle doors. In the lock control, output of the drive signal according to a handle operation is suspended. At a time of a P-set operation in which a shift position of the vehicle is set to a parking position, the lock controller executes a shift-linked in-cabin unlock control. The shift-linked in-cabin unlock control is a locking/unlocking control linked to the P-set operation. In the shift-linked in-cabin unlock control, the lock controller executes unlock control on the inside handle. In the unlock control, the drive signal is output according to a handle operation. In the shift-linked in-cabin unlock control, the lock controller maintains the lock control for the outside handle.

### CROSS REFERENCE TO RELATED APPLICATION

This application claims priority to Japanese Patent Application No. 2025-066325 filed on Apr. 14, 2025, which is incorporated herein by reference in its entirety including the specification, claims, drawings, and abstract.

### TECHNICAL FIELD

The present specification discloses a vehicle door lock control system.

### BACKGROUND

The vehicle door is provided with an inside handle and an outside handle. A lock control device that electronically controls a lock mechanism of a door in conjunction with these handle operations and electronic key operations is known. Such an electronic door lock system is also referred to as an E-latch system.

For example, in JP2014-141803 A, a vehicle-mounted device in communication with an electronic key is disclosed. When the shift position of the transmission of the vehicle is set to the parking position during the engine operation, the in-vehicle device locks and unlocks the door based on the electronic key operation.

In the so-called auto unlock function, an unlock operation of the occupant becomes unnecessary. For example, in the shift interlocking automatic unlocking function, when the shift position is set to the parking position, the lock of the vehicle door is automatically released.

However, if the lock of the vehicle door is released when the shift position is set to the parking position, the door may be opened from the outside of the vehicle.

Therefore, the present specification discloses a lock control system for a vehicle door capable of achieving both convenience at the time of getting off the vehicle and prevention of unintended door opening from outside the vehicle.

### SUMMARY

A lock control system for a vehicle door disclosed herein comprises a lock mechanism and a lock controller. The lock mechanism has a latch mechanism and a motor. The latch mechanism is switchable between an unlatched state and a latched state. In unlatched state, a vehicle door is openable with respect to a vehicle body. In latched state, the vehicle door is closed with respect to the vehicle body. The motor is capable of switching the latch mechanism between the unlatched state and the latched state. The lock controller outputs a drive signal to the motor. While the vehicle is traveling, the lock controller executes lock control on an inside handle and an outside handle provided on the respective vehicle doors. In the lock control, output of the drive signal according to a handle operation is suspended. At a time of a P-set operation in which a shift position of the vehicle is set to a parking position, the lock controller executes a shift-linked in-cabin unlock control. The shift-linked in-cabin unlock control is a locking/unlocking control linked to the P-set operation. In the shift-linked in-cabin unlock control, the lock controller executes unlock control on the inside handle. In the unlock control, the drive signal is output according to a handle operation. In the shift-linked in-cabin unlock control, the lock controller maintains the lock control for the outside handle.

According to the above configuration, the lock/unlock can be made different between the indoor side and the outdoor side by the shift-linked in-cabin unlock control. By setting the indoor side to the unlocked state, convenience at the time of getting out of the vehicle is secured. In addition, by maintaining the outside of the vehicle in the locked state, unintended door opening from the outside of the vehicle can be suppressed.

Further, in the above configuration, the lock controller may set a vehicle door selected in advance among the plurality of vehicle doors as a target of the shift-linked in-cabin unlock control.

According to the above configuration, the lock setting can be customized for each vehicle door. For example, in order to enable the child protector function for the rear door, the shift-linked in-cabin unlock control is not set to the rear door.

In the above configuration, after the inside handle is operated during the shift-linked in-cabin unlock control, the lock controller may execute in-cabin/out-of-cabin unlock control in place of the shift-linked in-cabin unlock control. In the in-cabin/out-of-cabin unlock control, the inside handle and the outside handle are set as targets of the unlock control.

According to the above configuration, after the door opening by the occupant is confirmed, the unlock setting is enabled for both of the handles on the indoor side and the outdoor side.

In the above configuration, the state after the vehicle door, which is brought into the unlatched state, being closed and returned to the latched state is called latch return. After latch return of the vehicle door by an operation of the inside handle, the lock controller may execute in-cabin/out-of-cabin unlock control in place of the shift-linked in-cabin unlock control. In the in-cabin/out-of-cabin unlock control, the inside handle and the outside handle are set as targets of the unlock control.

According to the above configuration, the vehicle door can be opened from the outside handle after the latch return.

According to the vehicle door lock control system disclosed in the present specification, it is possible to achieve both convenience at the time of getting off the vehicle and prevention of unintended door opening from outside the vehicle.

### BRIEF DESCRIPTION OF DRAWINGS

Embodiments of the present disclosure will be described based on the following figures, wherein:

FIG. 1 is a diagram illustrating a structure of a vehicle door;

FIG. 2 is a diagram illustrating a vehicle door lock control system according to the present embodiment;

FIG. 3 is a view for explaining an unlatched state (before a striker is opened);

FIG. 4 is a view for explaining an unlatched state (after the striker is opened);

FIG. 5 is a diagram illustrating a shift interlocking unlocking control flow;

FIG. 6 is a diagram illustrating a lock control flow of the front door when the shift-linked in-cabin unlock control is enabled; and

FIG. 7 is a diagram illustrating a lock control flow of the rear door when the shift-linked in-cabin unlock control is enabled.

### DESCRIPTION OF EMBODIMENTS

### 1. Vehicle Door Structure

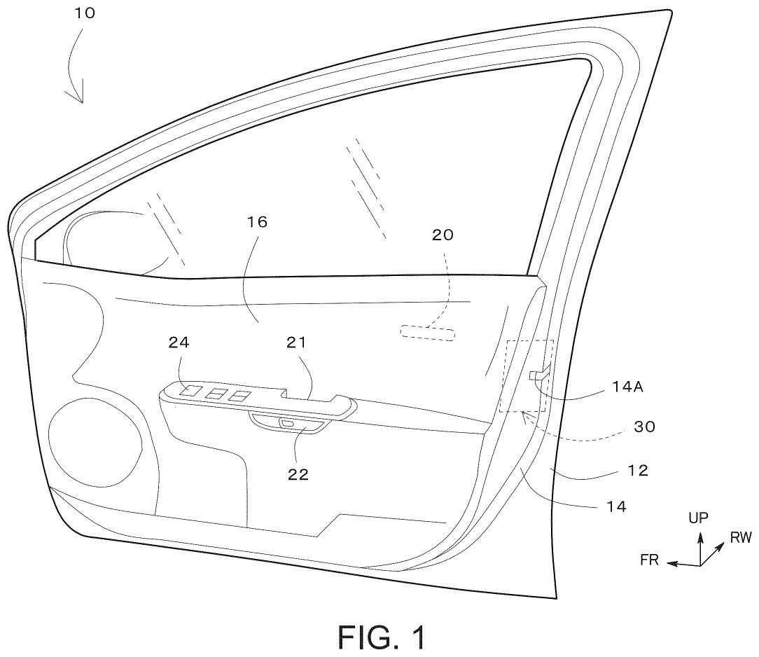

FIG. 1 illustrates a structure of a vehicle door according to the present embodiment. In FIGS. 1 to 4, the vehicle longitudinal direction is indicated by the FR axis.

The vehicle width direction is indicated by the RW axis. Further, the vertical direction is indicated by the UP axis. A forward direction of the longitudinal axis FR is defined as a forward direction. The right width direction of the width direction axis RW is defined as a positive direction. An upward direction of the height axis UP is defined as a positive direction.

FIG. 1 illustrates an inner structure of a vehicle door 10. The vehicle door 10 illustrated in FIG. 1 is a door of a driver's seat in a so-called right-hand drive vehicle.

The vehicle door 10 includes a door outer panel 12 and a door inner panel 14. A space is formed between the door outer panel 12 and the door inner panel 14. Devices such as the lock mechanism 30 are accommodated in this space. The door outer panel 12 is provided with an outside handle 20.

A door trim 16 is disposed on the vehicle interior side of the door inner panel 14. The door trim 16 is, for example, an interior part made of resin. A grip handle 21, an inside handle 22, and a door lock switch 24 are disposed on the door trim 16.

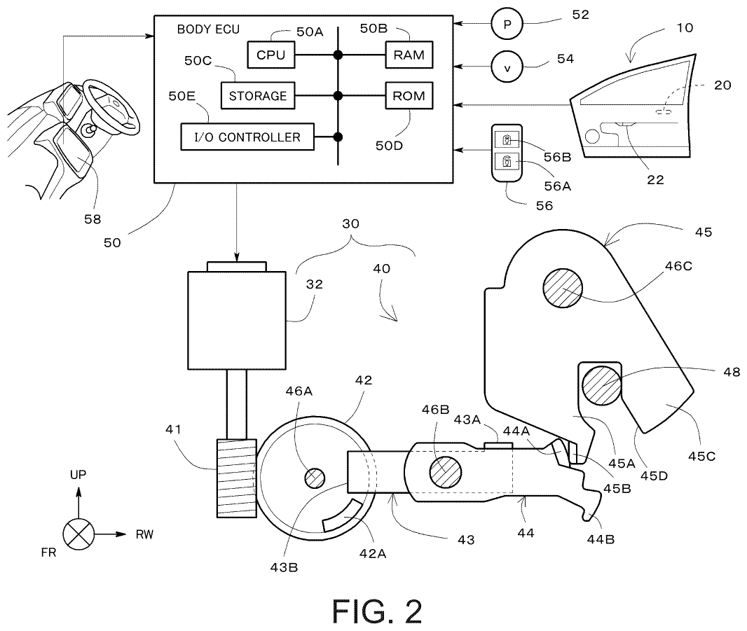

For example, the inside handle 22 is disposed on a side surface of the grip handle 21. The inside handle 22 is rotatable, for example, inward and outward in the vehicle width direction. The rotation of the inside handle 22 is detected by an inside handle sensor (not shown). The detected operation signal is transmitted to the body ECU 50 (see FIG. 2).

Referring to FIG. 1, door lock switch 24 is capable of switching between locking and unlocking of vehicle door 10. For example, the driver's seat door is provided with a centralized door lock switch 24. That is, in the driver's seat, the lock/unlock of all the vehicle doors 10 provided in the vehicle body can be controlled by operating the door lock switch 24. For a vehicle door 10 other than the driver's seat, locking/unlocking of the vehicle door 10 is switched by a door lock switch 24 provided on the vehicle door 10. The depression of the door lock switch 24 is detected by a switch sensor (not shown). The detected operation signal is transmitted to the body ECU 50 (see FIG. 2).

Referring to FIG. 1, an outside handle 20 is disposed on the door outer panel 12. The outside handle 20 is rotatable outward in the vehicle width direction. The rotation of the outside handle 20 is detected by an outside handle sensor (not shown). The detected operation signal is transmitted to the body ECU 50 (see FIG. 2).

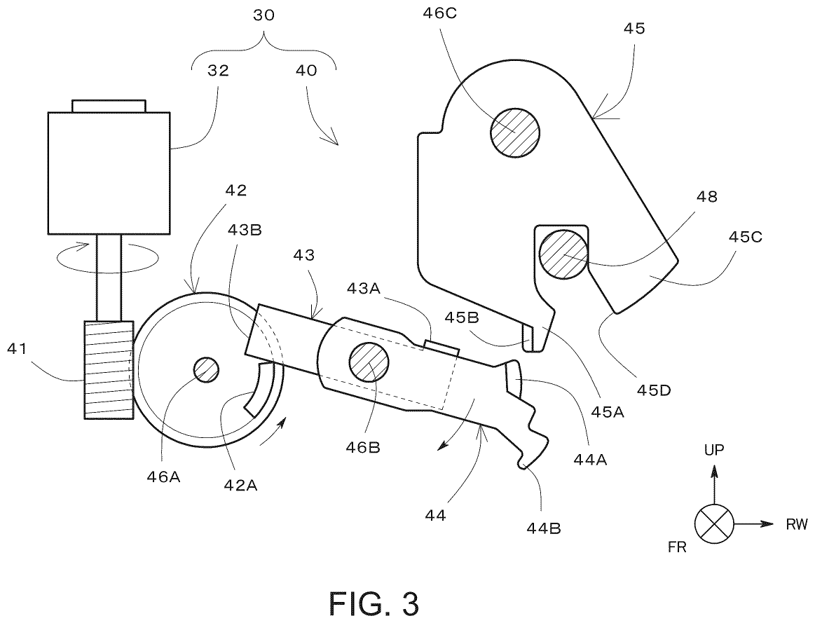

As described later, the pole 44 (see FIG. 2) is switched from the latched state (see FIG. 2) to the unlatched state (see FIG. 3) by the opening operation of the outside handle 20 and the inside handle 22. The outside handle 20 and the inside handle 22 are electrically connected to the pole 44 via the body ECU 50. Details of the electrical connection structure will be described later.

As a so-called emergency function, the outside handle 20 and the inside handle 22 may be mechanically connected to the pole 44. For example, the outside handle 20 and the inside handle 22 are connected to the wire connecting portion 44B of the pole 44 by wires (not shown).

FIG. 2 illustrates a lock control system for the vehicle door 10 according to the present embodiment. The lock control system is an electronic locking and unlocking system. For example, the lock control system according to the present embodiment is also referred to as an E latch system. The lock control system includes a body ECU 50 (lock controller) and a lock mechanism 30.

### 2. Body ECU (Lock Controller)

The body ECU 50 outputs a drive signal to the motor 32. The body ECU 50 receives various signals from the in-vehicle device. For example, the body ECU 50 receives an operation signal from a sensor (not shown) of the outside handle 20 and a sensor (not shown) of the inside handle 22 of the vehicle door 10. The body ECU 50 receives operation signals of the open button 56A and the close button 56B from the electronic key 56.

A signal related to the position of the shift lever is transmitted to the body ECU 50. For example, a P position switch 52 is disposed in the vehicle. When the P position switch 52 is depressed by the driver, the shift position is set to the parking position. This setting operation is also called a P-set operation. An operation signal associated with the P-set operation is transmitted to the body ECU 50.

A vehicle speed value is transmitted from the speed sensor 54 to the body ECU 50. As will be described later, when the vehicle speed value exceeds a predetermined speed threshold value, the body ECU 50 performs lock control on the outside handle 20 and the inside handle 22 provided on the respective vehicle doors 10. Details of the lock control will be described later.

A display 58 is disposed on the instrument panel of the vehicle cabin. The display 58 is, for example, a touch panel display. The occupant can operate the display 58 to change the lock/unlock setting. For example, a setting of enabling/disabling the shift-linked in-cabin unlock function and a setting of enabling/disabling the shift-linked in-cabin/out-of-cabin unlock function, which will be described later, can be set from the display 58. These settings can be individually set for a plurality of vehicle doors 10 provided in the vehicle. The set unlock setting is stored in the storage 50C or the ROM 50D of the body ECU 50.

The body ECU 50 is, for example, a computing device. The body ECU 50 includes a CPU 50A, a RAM 50B, a storage 50C, a ROM 50D, and an input/output controller 50e.

The CPU 50A is a central processing unit and is also referred to as a processor. The RAM 50B is, for example, a volatile storage device that temporarily stores data during work. The ROM 50D is a storage device capable of reading data. The storage 50C is a storage device capable of writing and reading data. The storage 50C includes, for example, a hard disk drive (HDD) and a solid state drive (SSD).

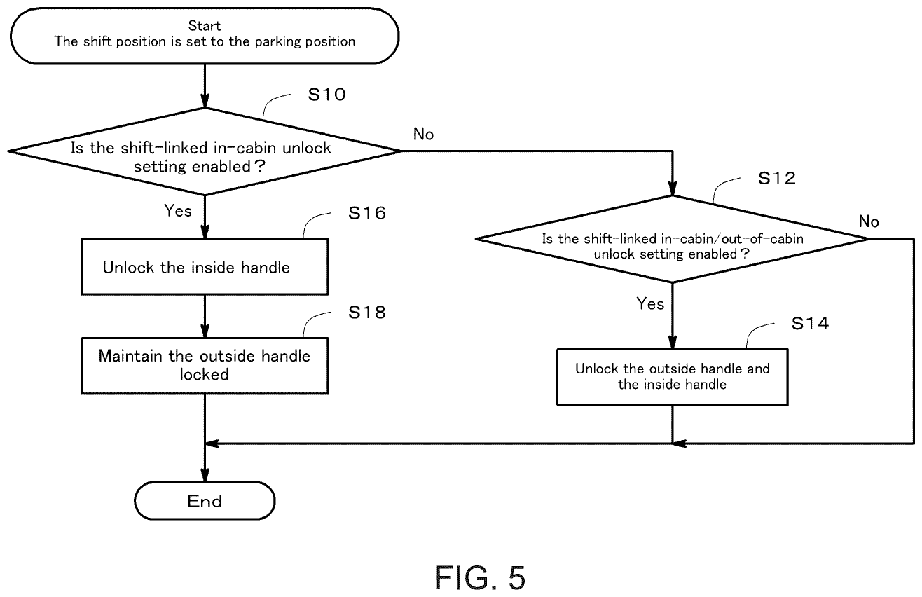

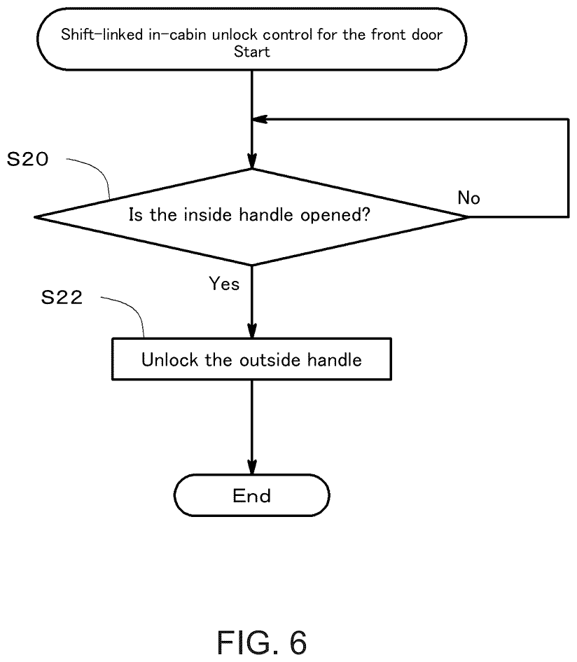

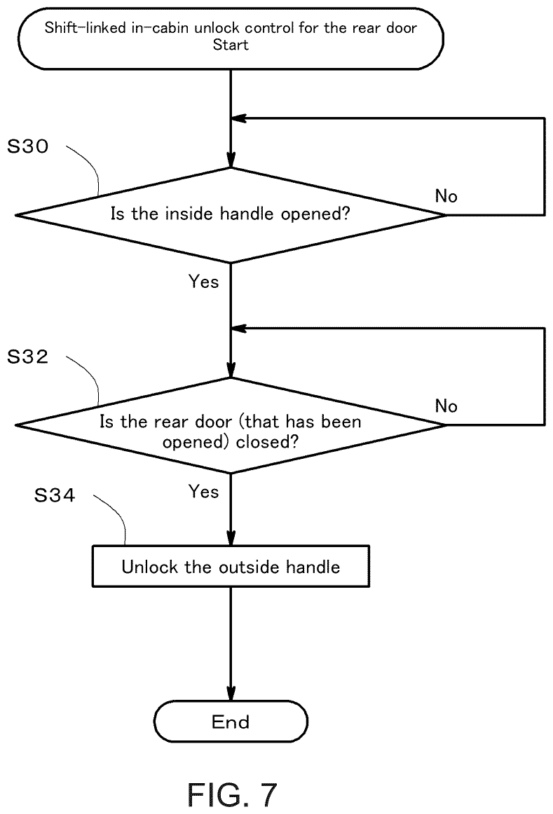

When the CPU 50A executes the program stored in the storage 50C or the ROM 50D, the CPU 50A can execute the shift-linked unlock control flow as illustrated in FIG. 5. The CPU 50A can execute a front door lock control flow as illustrated in FIG. 6. Further, the CPU 50A can execute a rear door lock control flow as illustrated in FIG. 7. Details of the flowcharts of FIGS. 5 to 7 will be described later.

### 3. Latch Mechanism

Referring to FIG. 2, the lock mechanism 30 includes a motor 32 and a latch mechanism 40. As described later, the latch mechanism 40 is switched between a latched state (door closed) and an unlatched state (door open) by driving the motor 32. The latch mechanism 40 includes a cylindrical worm 41, a worm wheel 42, a key lever 43, a pole 44, and a fork 45.

The cylindrical worm 41 is connected to the motor 32. The cylindrical worm 41 meshes with the worm wheel 42. The worm wheel 42 is provided with a hammer 42A. The key lever 43 extends in the vehicle width direction. As described later, the rear end portion 43B of the key lever 43 abuts against the hammer 42A.

The key lever 43 and the pole 44 have the rotation shaft 46B as a rotation axis. The pole 44 extends in the vehicle width direction. A contact portion 44A is provided above the front end of the pole 44. A buffer member such as a rubber pad may be disposed on the contact portion 44A. A wire connecting portion 44B is provided below the front end of the pole 44. A wire (not shown) extended from the outside handle 20 or the inside handle 22 is connected to the wire connecting portion 44B. When the vehicle door 10 is mechanically opened for emergency handling, the pole 44 is pulled downward from the

### Wire Connecting Portion 44b.

The fork 45 includes a pair of protrusions 45A and 45C. A holding groove 45D is formed between the protrusions 45A and 45C. The striker 48 is held in the holding groove 45D. A contact portion 45B is provided at the tip of the protrusion 45A. A buffer member such as a rubber pad may be disposed on the contact portion 45B.

The latch mechanism 40 is installed on the vehicle door 10, while the striker 48 is disposed on the vehicle body. For example, the striker 48 is attached to a pillar serving as a frame body of the entrance. The striker 48 is inserted into the holding groove 45D of the fork 45 from the slit 14A of the door inner panel 14 (see FIG. 1).

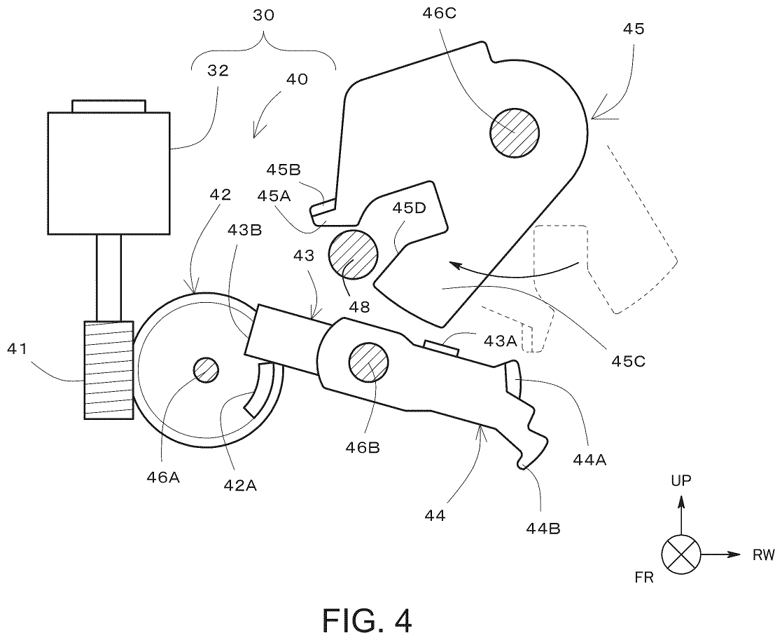

The state in which the striker 48 is held in the holding groove 45D of the fork 45 is the closed state of the vehicle door 10. As shown in FIG. 4, the state in which the striker 48 is removed from the holding groove 45D is the open state of the vehicle door 10.

### 4. Locking/Unlocking in Electronic Locking and Unlocking

The lock control system of the vehicle door 10 according to the present embodiment is an electronic locking/unlocking system. That is, the lock control system is capable of switching between locking/unlocking and latching/unlatching of the vehicle door 10 based on electrical control.

Locking/unlocking in the electronic locking/unlocking is performed via the body ECU 50. That is, the operation signal generated by the operation of the outside handle 20 and the inside handle 22 is transmitted to the body ECU 50. The CPU 50A of the body ECU 50 determines whether or not to output the drive signal to the motor 32 in accordance with the operation signal.

A state in which the drive signal is not output to the motor 32 despite the reception of the operation signal accompanying the handle operation is the locked state. In other words, the state in which the handle operation and the driving of the motor 32 are not interlocked is the locked state. In the locked state, even when the operation signal accompanying the handle operation is received, the CPU 50A of the body ECU 50 suspends the output of the drive signal to the motor 32.

Further, the state in which the drive signal is output to the motor 32 when the operation signal accompanying the handle operation is received is the unlock state. In other words, the state in which the handle operation and the motor drive are interlocked is the unlocked state. In the unlocked state, when an operation signal accompanying the handle operation is received, the CPU 50A of the body ECU 50 outputs a drive signal to the motor 32.

Here, in the vehicle door lock control system according to the present embodiment, lock/unlock can be independently set for each of the outside handle 20 and the inside handle 22. For example, the ROM 50D stores lock/unlock settings for each handle.

That is, as described later, the body ECU 50 can set the inside handle 22 to the unlocked state and set the outside handle 20 to the locked state. Such independent lock/unlock setting enables to set the shift-linked in-cabin unlock setting to be described later.

### 5. Latch/Unlatch

FIG. 2 illustrates the latch mechanism 40 in a latched state. In the latched state, the contact portion 44A of the pole 44 abuts against the contact portion 45B of the fork 45. In this state, clockwise rotation of the fork 45 is restricted. That is, the state in which the striker 48 is held in the holding groove 45D is maintained. In the latched state, the vehicle door 10 is closed with respect to the vehicle body.

When the drive signal is output to the motor 32, the motor 32 rotates. The rotation of the motor 32 causes the cylindrical worm 41 to rotate. This rotation is transmitted to the worm wheel 42. Referring to FIG. 3, when worm wheel 42 rotates counterclockwise about rotation shaft 46A, hammer 42A of worm wheel 42 pushes up rear end portion 43B of key lever 43.

As the hammer 42A is pushed up, the key lever 43 and the pole 44 rotate about the rotation shaft 46B. A biasing piece 43A is provided on an upper side of a front end of the key lever 43. When the rear end portion 43B of the key lever 43 is lifted, the front end portion of the key lever 43 is pushed down. At this time, the biasing piece 43A presses down the pole 44. As a result, the contact portion 44A of the pole 44 is separated downward from the contact portion 45B of the fork 45.

A state in which the contact portion 44A of the pole 44 is disengaged from the contact portion 45B of the fork 45, in other words, a state in which the fork 45 is rotatable clockwise is an unlatched state. The unlatched state includes both a state in which the fork 45 holds the striker 48 as shown in FIG. 3 and a state in which the striker 48 is disengaged from the fork 45 (door opening) as shown in FIG. 4. In the unlatched state, the vehicle door 10 can be opened with respect to the vehicle body.

For example, when the inside handle 22 is opened, the pole 44 is disengaged from the fork 45 (unlatching). When the occupant further opens the vehicle door 10, the fork 45 rotates clockwise in FIG. 4 about the rotation shaft 46C (see FIG. 4). Accordingly, the striker 48 is detached from the fork 45, and the vehicle door 10 is opened with respect to the vehicle body.

### 6. Shift-Linked Unlock Flow

FIG. 5 illustrates a flowchart of the shift interlocking unlocking control. Each step of this flowchart is executed by the CPU 50A of the body ECU 50.

This flow is started when the shift position is set to the parking position (P-set operation). That is, the flow of FIG. 5 is the locking and unlocking control in conjunction with the P-set operation.

Before the P-set operation, for example, the shift position is set to the drive position. That is, the vehicle is traveling. While the vehicle is traveling, the body ECU 50 lock-controls the interior side and the exterior side of all the vehicle doors 10. That is, even when the outside handle 20 and the inside handle 22 of each vehicle door 10 are operated, the body ECU 50 suspends the output of the drive signal to the motor 32. Whether or not the vehicle is traveling is determined according to whether or not the vehicle speed value transmitted from the speed sensor 54 exceeds a predetermined speed threshold.

When the vehicle is parked in the parking area or the like and the shift position is set to the parking position (P-set operation), the CPU 50A of the body ECU 50 refers to the shift-linked lock setting stored in the storage 50C or the ROM 50D.

The shift-linked lock setting is set to any one of values of “shift-linked lock setting invalid”, “shift-linked in-cabin/out-of-cabin unlock setting valid”, and “shift-linked in-cabin unlock setting valid”.

The CPU 50A refers to the shift-linked lock setting and determines whether or not the shift-linked in-cabin unlock setting is enabled (S10). When the shift-linked in-cabin unlock control is invalid, the CPU 50A determines whether or not the shift-linked in-cabin/out-of-cabin unlock setting is valid (S12). When the shift-linked in-cabin/out-of-cabin unlock setting is disabled, the CPU 50A maintains the lock control for the outside handle 20 and the inside handle 22 of the vehicle door 10 even when the shift position is set to the parking position.

In step S12, when the shift-linked in-cabin/out-of-cabin unlock setting is enabled, the CPU 50A executes the shift-linked in-cabin/out-of-cabin unlock control in conjunction with the P-set operation. That is, the CPU 50A executes the unlock control instead of the lock control on the outside handle 20 and the inside handle 22 of the vehicle door 10 (S14).

In step S10, when the shift-linked in-cabin unlock setting is enabled, the CPU 50A unlocks the indoor side of the vehicle door 10. That is, the CPU 50A executes the unlock control instead of the lock control on the inside handle 22 of the vehicle door 10 (S16). On the other hand, the CPU 50A maintains the lock control for the outside handle 20 of the vehicle door 10 (S18).

The shift-linked in-cabin unlock control suppresses unintended door opening from the outside of the vehicle at the time of the P-set operation.

FIG. 6 illustrates a control flow of the front door during the shift-linked in-cabin unlock control. The CPU 50A determines whether or not the inside handle 22 has been opened (S20). For example, the CPU 50A determines the presence or absence of an operation signal from an inside handle sensor (not shown). When the operation signal is not received, the CPU 50A waits for reception of the operation signal.

When the opening operation of the inside handle 22 is detected, the CPU 50A executes the in-cabin/out-of-cabin unlock control instead of the shift-linked indoor unlock control (S22). That is, the CPU 50A sets the outside handle 20 and the inside handle 22 as an unlock control target. Thus, the vehicle door 10 can be opened from the outside of the vehicle after the vehicle door 10 is once opened and closed.

FIG. 7 illustrates a control flow of the rear door during the shift-linked in-cabin unlock control. The CPU 50A determines whether or not the inside handle 22 of the rear door has been opened (S30). When the operation signal indicating the opening operation is not received, the CPU 50A waits for reception of the signal.

When the opening operation of the inside handle 22 is detected, the CPU 50A determines whether or not the rear door that has been opened is closed (returned to the latch state) (S32). The detection of the latch return can be determined by the presence or absence of a detection signal from the door sensor. While the state in which the rear door is opened is maintained, the CPU 50A waits until the latch return.

When the latch return of the rear door is detected, the CPU 50A executes the in-cabin/out-of-cabin unlock control on the rear door instead of the shift-linked in-cabin unlock control (S34). That is, the CPU 50A sets the outside handle 20 and the inside handle 22 as an unlock control target. Thus, the vehicle door 10 can be opened from the outside of the vehicle after the vehicle door 10 is once opened and closed.

### 7. Door-Specific Customization of Shift-Linked Lock Setting

In the above-described embodiment, the shift-linked in-cabin unlock control is set to be effective for all the doors of the vehicle, but the lock/unlock may be set for each door.

For example, the body ECU 50 may set only the vehicle door 10 set in advance as a target of execution of the shift-linked in-cabin unlock control. For example, such customization can be performed by an operation from the display 58 (see FIG. 2).

For example, when a child is riding in the rear seat, if the shift-linked in-cabin unlock control is set to be effective in the rear door, the child may open the rear door against the driver's intention. In such a case, the vehicle door 10 of the rear seat can be operated as intended by the driver by disabling the unlocking in the shift-linked room, which is contrary to the child protector function.

The present disclosure is not limited to the present embodiments described above, and includes all changes and modifications without departing from the technical scope or the essence of the present disclosure defined by the claims.

1. A lock control system for a vehicle door, the lock control system comprising:
a lock mechanism having a latch mechanism and a motor; and
a lock controller that outputs a drive signal to the motor; wherein the latch mechanism is switchable between an unlatched state in which a vehicle door is openable with respect to a vehicle body and a latched state in which the vehicle door is closed with respect to the vehicle body;
the motor is capable of switching the latch mechanism between the unlatched state and the latched state;
while the vehicle is traveling, the lock controller executes lock control on an inside handle and an outside handle provided on the respective vehicle doors, and in the lock control, output of the drive signal according to a handle operation is suspended;
at a time of a P-set operation in which a shift position of the vehicle is set to a parking position, the lock controller executes a shift-linked in-cabin unlock control, and the shift-linked in-cabin unlock control is a locking/unlocking control linked to the P-set operation;
in the shift-linked in-cabin unlock control, the lock controller executes unlock control on the inside handle, and in the unlock control, the drive signal is output according to a handle operation; and
in the shift-linked in-cabin unlock control, the lock controller maintains the lock control for the outside handle.

2. The lock control system for a vehicle door according to claim 1, wherein
the lock controller sets a vehicle door selected in advance among the plurality of vehicle doors as a target of the shift-linked in-cabin unlock control.

3. The lock control system for a vehicle door according to claim 1, wherein
after the inside handle is operated during the shift-linked in-cabin unlock control, the lock controller executes in-cabin/out-of-cabin unlock control in place of the shift-linked in-cabin unlock control, and
in the in-cabin/out-of-cabin unlock control, the inside handle and the outside handle are set as targets of the unlock control.

4. The lock control system for a vehicle door according to claim 1, wherein
after latch return in which, after the vehicle door, which is brought into the unlatched state by an operation of the inside handle, is closed and is returned to the latched state, the lock controller executes in-cabin/out-of-cabin unlock control in place of the shift-linked in-cabin unlock control, and
in the in-cabin/out-of-cabin unlock control, the inside handle and the outside handle are set as targets of the unlock control.
